(19) United States
(12) Patent Application Publication
(10) Pub. No.: US 2006/0145077 A1
(43) Pub. Date: Jul. 6, 2006

(54) Image sensor using optical fiber

(75) Inventor: Sang Sik Kim, Suwon-city (KR)

Correspondence Address: MCKENNA LONG & ALDRIDGE LLP, 1900 K STREET, NW, WASHINGTON, DC, 20006, US

(73) Assignee: DONGBU-ANAM SEMICONDUCTOR, Kangnam-Ku (KR)

(21) Appl. No.: 11/320,448

(22) Filed: Dec. 29, 2005

(30) Foreign Application Priority Data
Dec. 30, 2004 (KR) 10-2004-0116517

(51) Int. Cl. G01J 5/02

(52) U.S. Cl. 250/339.02

(57) ABSTRACT

An image sensor using an optical fiber is provided, in which less pixel straying is generated, so that clearer images can be obtained. The image sensor includes an image sensing portion for sensing an optical signal per pixel, the optical signal traveling along an input path; and an image aligner disposed in the input path of the image sensing portion for converting a tilted light signal into a perpendicular light signal.

### CROSS-REFERENCE TO RELATED APPLICATION

This application claims the benefit of Korean Patent Application No. 10-2004-0116517, filed on Dec. 30, 2004, which is hereby incorporated by reference as if fully set forth herein.

### BACKGROUND OF THE INVENTION

1. Field of the Invention

The present invention relates to an image sensor using an optical fiber, and more particularly, to an image sensor using optical fiber that generates less pixel straying and obtains clearer images.

2. Discussion of the Related Art

Image sensors are semiconductor devices for converting an optical image to an electrical signal and include a charge-coupled device (CCD) and a CMOS image sensor having a number of metal-oxide-semiconductor (MOS) transistors, corresponding to the number of pixels, integrated on a single chip with peripheral circuitry for sequentially outputting the electrical signals of the MOS transistors. With miniaturization and a more highly integrated multi-pixel structure of the image sensor, more pixels are formed per unit area. With the decrease in pixel size, the respective sizes of the microlenses and the color filters of a color filter layer, which are formed in an on-chip manner, also become small. As the size of unit pixel becomes small, a photodiode area that receives light is reduced, thereby reducing photosensitivity. To enhance the photosensitivity of an image sensor, the fill factor may be improved. In other words, the photodiode area is increased with respect to the area of the device itself. Increase of the fill factor is limited, however, by the presence of the associated logic and signal processing circuitry of each photodiode. Enhanced photosensitivity may also be achieved by focusing light from an object image, i.e., incident light, which is refracted by, for example, a microlens provided to each photodiode, to concentrate the incident light into the photodiode and away from the adjacent areas where there is no photodiode surface. In doing so, light parallel to a light axis of the microlens is refracted by the microlens such that a focal point is formed at a point along the light axis.

In any event, photosensitivity is improved when the photodiode area receives more light. To this end, the size of an aperture formed in a light shielding layer may be increased. The light shielding layer is typically formed by patterning a metal wiring layer including a plurality of apertures arranged in correspondence to a microlens layer. The light shielding layer blocks light traveling toward underlying areas existing between the photodiodes and passes light through the apertures to strike a corresponding photodiode positioned directly under a microlens. As an angle of incidence increases, however, aperture size should be increased, which diminishes the light-shielding function of the metal wiring layer. For example, with respect to diagonal apertures, the apertures formed closest to center of the light-shielding layer should be shifted by as much as 1-3 μm to match the incidence angle at the diagonal.

Incident light enters an image sensor at all points across an image plane. For a more uniform reproduction of images, that is, with a greater uniformity across the image plane, there should be a balance of intensity between the respective energies of light energy entering closest to a center region of the image sensor and light energy entering closest to a corner region of the image sensor. To this end, the microlenses are formed to have specific varying sizes across the image plane, with larger microlenses being disposed in the corner regions and the microlenses becoming gradually smaller toward the center region. To achieve such precise size variation, a costly precision mask is required. Meanwhile, the light-shielding metal wiring layer should be provided with apertures properly positioned to compensate for the varying angles of incidence between the center and edges (diagonals) of the image sensor. That is, light entering the image sensor obliquely (at high angle of incidence) affects a rate of refraction of the light and reduces focusing efficiency of the microlens, thereby causing an energy loss in the transmitted light reaching the lower layers, i.e., the photodiodes. Excessive light refraction may cause the light to strike the photodiode of an adjacent pixel (“a pixel straying”) and generate blurring in the reproduced image.

For example, in the case of an incident angle to an image sensor having a ¼″ optical, the image sensor is designed to have a viewing angle (“angle of view” or “AOV”) of 55°-65° based on a reference viewing angle of 55° that allows the human eye to sense color. High-incidence images are more susceptible to decreases in image sensor size, since there is greater difficulty is controlling the travel path of the light energy from such sources so that the light accurately strikes a photoelectric conversion portion, i.e., a specific photodiode. This is a result of the trend toward higher pixel counts, greater miniaturization, and enhanced performance characteristics. These larger angles of incidence also increase the focal distance, further degrading light focusing efficiency.

In the fabrication of a CCD or CMOS image sensor, after an on-chip color filter is formed on a silicon wafer, the wafer undergoes an assembly process using energy dispersive x-ray spectroscopy, including cutting, adhesion, and curing of a die; wiring and adhesion of the glass lid; and marking. A package test is performed on the final product. A contemporary image sensor, after packaging, is shown in FIG. 1.

Referring to FIG. 1, an image sensor 10 is fixed to a package frame 14 sealed with a transparent glass lid 12. Light from an object source enters the corner region, except for the center region, of the image sensor at a tilt angle of about 30°. To concentrate the light energy from an object source onto the photoelectric conversion device, i.e., photodiode, with minimum loss, it is necessary to properly contract the condensing lens toward the center region of the image sensor in accordance with the incident angle.

Referring to FIG. 2, illustrating the levels of pixel straying present in a variety of image sensors, it can be noted that stray light toward the diagonal increases with an increased pixel count or higher resolution, which necessitates larger apertures to enhance the light focusing efficiency of a corresponding microlens. The necessary increase in aperture size, however, may be too large to be realized by an image sensor. Also, an increase in refraction rate, due to an increased angle of incidence from the object image, degrades photosensitivity and causes unclear images or blurring as the reflected light again enters an adjacent pixel.

### SUMMARY OF THE INVENTION

Accordingly, the present invention is directed to an image sensor using an optical fiber that substantially obviates one or more problems due to limitations and disadvantages of the related art.

The present invention is to provide an image sensor in which light is focused with less straying to obtain clear images.

Additional advantages, objects, and features of the invention will be set forth in the description which follows and will become apparent to those having ordinary skill in the art upon examination of the following. The objectives and other advantages of the invention may be realized and attained by the structure particularly pointed out in the written description and claims hereof as well as the appended drawings.

To achieve these objects and other advantages in accordance with the invention, as embodied and broadly described herein, there is provided an image sensor comprising an image sensing portion for sensing an optical signal per pixel, the optical signal traveling along an input path; and an image aligner disposed in the input path of the image sensing portion for converting a tilted light signal into a perpendicular light signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention illustrate exemplary embodiments of the invention and together with the description serve to explain the principle of the invention. In the drawings:

FIG. 1 is a structural view of a contemporary image sensor after packaging;

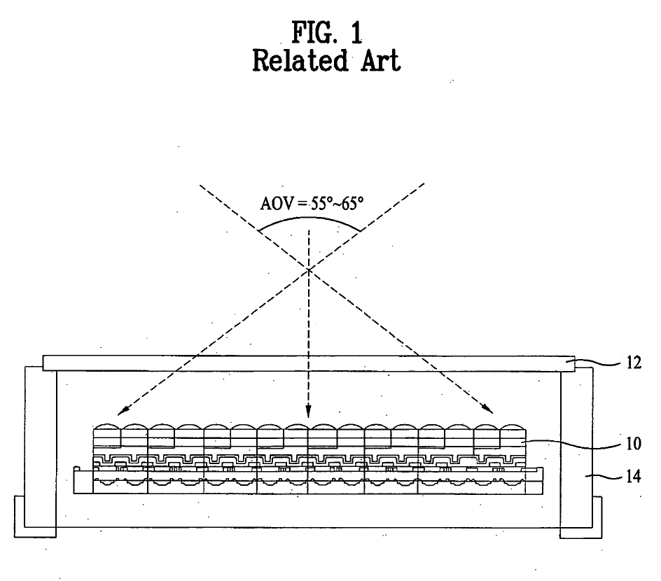

FIG. 2 is a graph illustrating the level of pixel straying present in a variety of contemporary image sensors; and

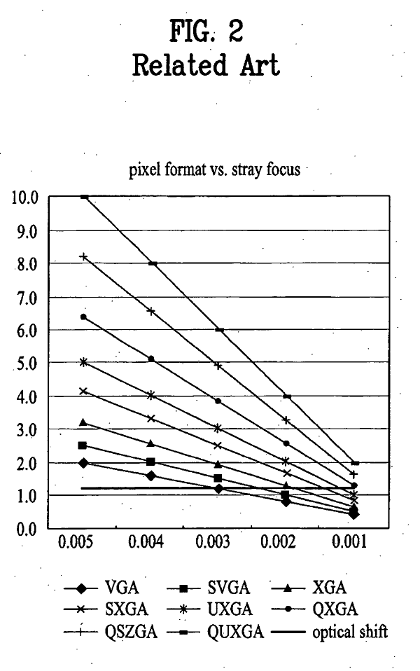

FIG. 3 is a diagram of an exemplary image sensor according to the present invention.

### DETAILED DESCRIPTION OF THE INVENTION

Reference will now be made in detail to exemplary embodiments of the present invention, examples of which are illustrated in the accompanying drawings. Wherever possible, like reference designations will be used throughout the drawings to refer to the same or similar parts.

In fabricating an image sensor, resolution is determined by the number of photodiodes existing in an image plane. With the trend toward high pixel counts and miniaturization, it is desirable for light from on object source focused onto the image plane through a light-receiving lens to be received at an incidence angle of 50°-60°. To efficiently focus the light, a plurality of color filters and a corresponding microlens layer are formed per pixel, such that a greater incidence angle is formed toward the corners of the image sensor. The margin of the incidence angle can be increased if an inner or lower layer, disposed below the color filter layer or below the metal wiring layer, is thinly formed.

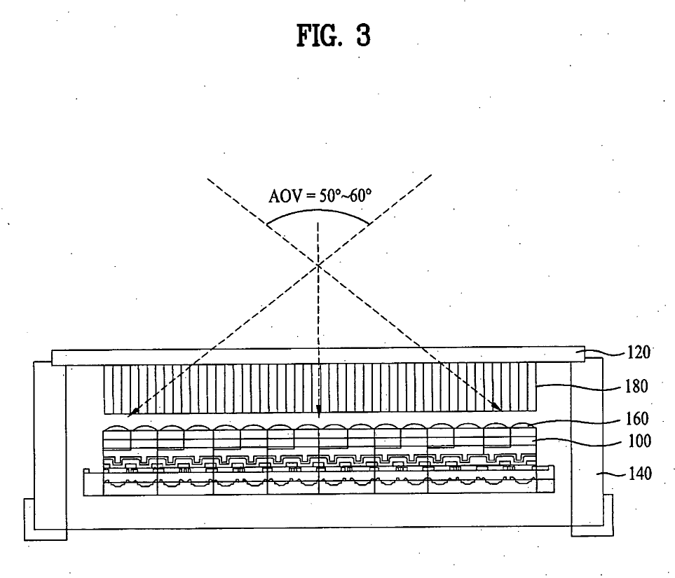

To overcome the effects of high refraction rates and lower light focusing efficiency caused by greater incidence angles and the effects of larger apertures in the metal light-shielding layer, which diminish its light-shielding capability, the image sensor of the present invention employs an optical fiber. An image sensor using an optical fiber according to the present invention is shown in FIG. 3.

Referring to FIG. 3, an image sensor 100 that has undergone a silicon wafer process is packaged in a package frame 140, and a bundle of optical fibers 180 is arranged between a transparent (e.g., glass) lid 120 and a microlens layer 160. The optical fibers 180 are encapsulated in the glass lid 120. The bundle of optical fibers has an area corresponding to an image sensing portion and is attached to the glass lid 120 using a transparent epoxy (not shown) to be disposed above the color filter layer. The optical fiber serves to change the traveling direction of the light entering the glass lid 120 into a path perpendicular to the image plane using the total amount of refraction generated in the length of the optical fiber. In other words, the optical fiber constitutes an image aligner that converts a tilted light signal into a perpendicular light signal, the conversion being performed after the light exits a lower surface of the glass lid.

Thus, the image sensor 100 senses an optical signal per pixel, and the optical signal traveling along an input path of the image sensor. The image aligner 180 is disposed in the input path of the image sensor 100 to convert the tilted light signal of the input path into a perpendicular light signal for entering the image sensor via the microlens layer 160.

Each of the optical fibers has a diameter of 1-10 μm and a length of 1-10 μm, depending on the size of a unit pixel. The diameter is between one-fifth and five times the unit pixel size, and the length depends on the package type.

In the packaged image sensor, in which the top of the package frame is sealed with the glass lid, an image aligner, including the bundle of optical fibers, is arranged above the image sensing portion and may be attached to the bottom of the glass lid or to the top of the image sensing portion. The optical transmission path of the optical fibers may be provided with an infrared cutoff or band stop filter.

Accordingly, using the bundle of optical fibers of the present invention, perpendicularly traveling converted light is focused the image plane, thereby improving the light focusing efficiency of light incident at the corners of the image sensor. Therefore, in the process of forming the light-shielding layer to compensate for the tilt angle of light from an object image, which is achieved by patterning a metal wiring layer to define each pixel, a process margin can be increased, thereby enabling an increase in focusing efficiency and a correspondingly improved photoelectric conversion effect. A larger process margin enables a reduction in fabrication costs related to masking and the formation of the light shielding and color filter layers. Also, there is no need for a separate infrared cutoff filter, which can in the present invention be embodied in the optical fiber to thereby reduce the size of the package frame. This enables a smaller optical module, thereby enabling a wider variety of application. Moreover, by inducing perpendicular light before its entry into the light sensing portion, the internal travel distance of the light is reduced for a shorter focal distance to benefit focusing efficiency.

It will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. An image sensor, comprising:
an image sensing portion for sensing an optical signal per pixel, the optical signal traveling along an input path; and
an image aligner disposed in the input path of said image sensing portion for converting a tilted light signal into a perpendicular light signal.

2. The image sensor as claimed in claim 1, further comprising:
an image sensor package for receiving said image sensing portion and said image aligner, said image sensor package having an upper side formed from a transparent lid.

3. The image sensor as claimed in claim 2, wherein said image aligner is attached to a bottom surface of the transparent lid.

4. The image sensor as claimed in claim 2, wherein said image aligner is attached to a top surface of said image sensing portion.

5. The image sensor as claimed in claim 2, wherein the transparent lid is made of glass.

6. The image sensor as claimed in claim 2, said image aligner comprising:
a bundle of optical fibers arranged between the transparent lid and a microlens layer.

7. The image sensor as claimed in claim 6, wherein the optical fibers of said bundle of optical fibers are encapsulated in the transparent lid.

8. The image sensor as claimed in claim 6, wherein said bundle of optical fibers has an area corresponding to said image sensing portion.

9. The image sensor as claimed in claim 6, wherein said bundle of optical fibers has an area corresponding to said image sensing portion.

10. The image sensor as claimed in claim 6, wherein said bundle of optical fibers is attached to the transparent lid using a transparent epoxy.

11. The image sensor as claimed in claim 6, wherein said bundle of optical fibers is disposed above a color filter layer.

12. The image sensor as claimed in claim 6, wherein each of the optical fibers of said bundle of optical fibers has a diameter of 1-10 μm and a length of 1-10 μm, depending on the size of a unit pixel.

13. The image sensor as claimed in claim 12, wherein the length varies according to package type.

14. The image sensor as claimed in claim 12, wherein the length of each of the optical fibers of said bundle of optical fibers is fixed according to the size of a unit pixel.

15. The image sensor as claimed in claim 14, wherein the diameter is between one-fifth and five times the unit pixel size.

16. The image sensor as claimed in claim 6, further comprising:
an infrared cutoff filter provided to the optical fibers of said bundle of optical fibers.
